(19) United States
(12) Patent Application Publication
(10) Pub. No.: US 2010/0093935 A1
(43) Pub. Date: Apr. 15, 2010

(54) METHOD OF PREPARING POLYGLUTAMATE CONJUGATES

(75) Inventors: Sang Van, San Diego, CA (US); Sanjib Kumar Das, Oceanside, CA (US); Gang Zhao, Vista, CA (US); Lei Yu, Carlsbad, CA (US)

Correspondence Address: KNOBBE MARTENS OLSON & BEAR LLP, 2040 MAIN STREET, FOURTEENTH FLOOR, IRVINE, CA, 92614, US

(73) Assignee: NITTO DENKO CORPORATION, Osaka (JP)

(21) Appl. No.: 12/579,287

(22) Filed: Oct. 14, 2009

Related U.S. Application Data
(60) Provisional application No. 61/105,769, filed on Oct. 15, 2008.
(60) Provisional application No. 61/106,100, filed on Oct. 16, 2008.

(51) Int. Cl. C08G 63/91; C08G 69/48

(52) U.S. Cl. 525/54.2; 525/418; 525/420

(57) ABSTRACT

Methods for preparing and isolating polymer conjugates that include a recurring unit of Formulae (I) and (Ia) are described herein. The polymer conjugates can include an anti-cancer drug.

### CROSS-REFERENCE TO RELATED APPLICATIONS

This application claims priority to U.S. Provisional Patent Application No. 61/105,769, entitled “METHOD OF PREPARING POLYGLUTAMATE CONJUGATES” filed Oct. 15, 2008; and 61/106,100 entitled “METHOD OF PREPARING POLYGLUTAMATE CONJUGATES” filed Oct. 16, 2008; which are incorporated herein by reference in their entireties, including any drawings.

### BACKGROUND

1. Field

This application relates generally to methods of making biocompatible water-soluble polymers with pendant functional groups. In particular, this application relates to methods of making polyglutamic acid and polyglutamate conjugates that can be useful for a variety of drug delivery applications.

2. Description of the Related Art

A variety of systems have been used for the delivery of drugs, biomolecules, and imaging agents. For example, such systems include capsules, liposomes, microparticles, nanoparticles, and polymers.

A variety of polyester-based biodegradable systems have been characterized and studied. Polylactic acid (PLA), polyglycolic acid and their copolymers polylactic-co-glycolic acid (PLGA) are some of the most well-characterized biomaterials with regard to design and performance for drug-delivery applications. See Uhrich, K. E.; Cannizzaro, S. M.; Langer, R. S. and Shakeshelf, K. M. “Polymeric Systems for Controlled Drug Release,” Chem. Rev. 1999, 99, 3181-3198 and Panyam J, Labhasetwar V. “Biodegradable nanoparticles for drug and gene delivery to cells and tissue,” Adv. Drug. Deliv. Rev. 2003, 55, 329-47. Also, 2-hydroxypropyl methacrylate (HPMA) has been widely used to create a polymer for drug-delivery applications. Biodegradable systems based on polyorthoesters have also been investigated. See Heller, J.; Barr, J.; Ng, S. Y.; Abdellauoi, K. S. and Gurny, R. “Poly(ortho esters): synthesis, characterization, properties and uses.” Adv. Drug Del. Rev. 2002, 54, 1015-1039. Polyanhydride systems have also been investigated. Such polyanhydrides are typically biocompatible and may degrade in vivo into relatively non-toxic compounds that are eliminated from the body as metabolites. See Kumar, N.; Langer, R. S. and Domb, A. J. “Polyanhydrides: an overview,” Adv. Drug Del. Rev. 2002, 54, 889-91.

Amino acid-based polymers have also been considered as a potential source of new biomaterials. Poly-amino acids having good biocompatibility have been investigated to deliver low molecular-weight compounds. A relatively small number of polyglutamic acids and copolymers have been identified as candidate materials for drug delivery. See Bourke, S. L. and Kohn, J. “Polymers derived from the amino acid L-tyrosine: polycarbonates, polyarylates and copolymers with poly(ethylene glycol).” Adv. Drug Del. Rev., 2003, 55, 447- 466.

Administered hydrophobic anticancer drugs and therapeutic proteins and polypeptides often suffer from poor bio-availability. Such poor bio-availability may be due to incompatibility of bi-phasic solutions of hydrophobic drugs and aqueous solutions and/or rapid removal of these molecules from blood circulation by enzymatic degradation. One technique for increasing the efficacy of administered proteins and other small molecule agents entails conjugating the administered agent with a polymer, such as a polyethylene glycol (“PEG”) molecule, that can provide protection from enzymatic degradation in vivo. Such “PEGylation” often improves the circulation time and, hence, bio-availability of an administered agent.

PEG has shortcomings in certain respects, however. For example, because PEG is a linear polymer, the steric protection afforded by PEG is limited, as compared to branched polymers. Another shortcoming of PEG is that it is generally amenable to derivatization at its two terminals. This limits the number of other functional molecules (e.g. those helpful for protein or drug delivery to specific tissues) that can be conjugated to PEG.

Polyglutamic acid (PGA) is another polymer of choice for solubilizing hydrophobic anticancer drugs. Many anti-cancer drugs conjugated to PGA have been reported. See Chun Li. “Poly(L-glutamic acid)-anticancer drug conjugates.” Adv. Drug Del. Rev., 2002, 54, 695-713. However, none are currently FDA-approved.

Paclitaxel, extracted from the bark of the Pacific Yew tree, is a FDA-approved drug for the treatment of ovarian cancer and breast cancer. Wani et al. “Plant antitumor agents. VI. The isolation and structure of taxol, a novel antileukemic and antitumor agent from Taxus brevifolia,” J. Am. Chem. Soc. 1971, 93, 2325-7. However, like other anti-cancer drugs, paclitaxel suffers from poor bio-availability due to its hydrophobicity and insolubility in aqueous solution. One way to solubilize paclitaxel is to formulate it in a mixture of Cremophor-EL and dehydrated ethanol (1:1, v/v). Sparreboom et al. “Cremophor EL-mediated Alteration of Paclitaxel Distribution in Human Blood: Clinical Pharmacokinetic Implications,” Cancer Research, 1999, 59, 1454-1457. This formulation is currently commercialized as Taxol® (Bristol-Myers Squibb). Another method of solubilizing paclitaxel is by emulsification using high-shear homogenization. Constantinides et al. “Formulation Development and Antitumor Activity of a Filter-Sterilizable Emulsion of Paclitaxel,” Pharmaceutical Research 2000, 17, 175-182. Recently, polymer-paclitaxel conjugates have been advanced in several clinical trials. Ruth Duncan “The Dawning era of polymer therapeutics,” Nature Reviews Drug Discovery 2003, 2, 347-360. More recently, paclitaxel has been formulated into nano-particles with human albumin protein and has been used in clinical studies. Damascelli et al. “Intraarterial chemotherapy with polyoxyethylated castor oil free paclitaxel, incorporated in albumin nanoparticles (ABI-007): Phase II study of patients with squamous cell carcinoma of the head and neck and anal canal: preliminary evidence of clinical activity.” Cancer, 2001, 92, 2592-602, and Ibrahim et al. “Phase I and pharmacokinetic study of ABI-007, a Cremophor-free, protein-stabilized, nanoparticle formulation of paclitaxel,” Clin. Cancer Res. 2002, 8, 1038-44. This formulation is currently commercialized as Abraxane® (American Pharmaceutical Partners, Inc.).

### SUMMARY

Disclosed herein are methods for synthesizing polymer conjugates that utilize a water-soluble coupling agent. Also disclosed herein are methods for isolating the polymer conjugate using no or minimal amount of organic solvents, such as chlorinated solvents.

An embodiment described herein relates to a method of preparing a polymer conjugate that can include: reacting a first reactant and a second reactant in the presence of a water-soluble coupling agent to yield a reaction mixture.

Another embodiment described herein relates to a method for isolating a polymer conjugate synthesized using a water-soluble coupling agent that can include intermixing an acidic aqueous solution with the reaction mixture and collecting the polymer conjugate.

These and other embodiments are described in greater detail below.

### BRIEF DESCRIPTION OF THE DRAWINGS

FIG. 1 illustrates one example of a reaction scheme for preparation of a polyglutamic acid-paclitaxel conjugate.

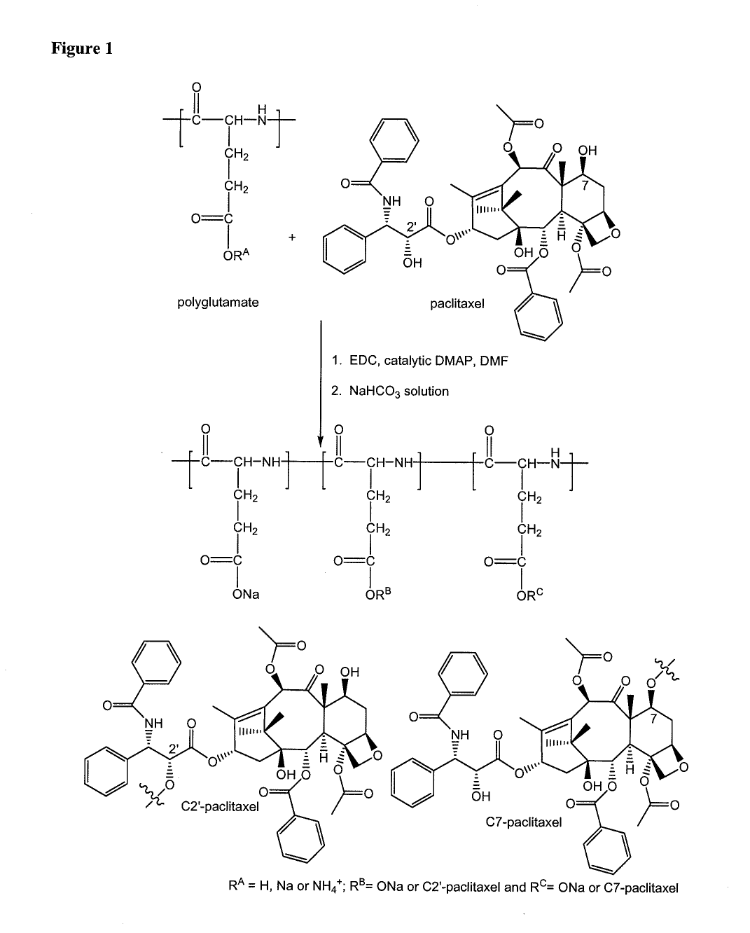

### DETAILED DESCRIPTION

Unless defined otherwise, all technical and scientific terms used herein have the same meaning as is commonly understood by one of ordinary skill in the art. All patents, applications, published applications and other publications referenced herein are incorporated by reference in their entirety unless stated otherwise. In the event that there are a plurality of definitions for a term herein, those in this section prevail unless stated otherwise.

A “stabilizing agent” is a substituent that enhances bioavailability and/or prolongs the half-life of a carrier-drug conjugate in vivo by rendering it more resistant to hydrolytic enzymes and less immunogenic. An exemplary stabilizing agent is polyethylene glycol (PEG).

As used herein, the term “water-soluble” is used in its ordinary sense, and describes a compound that can be completely dissolved in water at a concentration at least of 3 grams per 100 mL of water at pH equal to 7. See Shriner at al., The Systematic Identification of Organic Compounds, §5.1.1, (6^{th} ed. 1980).

The term “intermixing” as used herein refers to any method that results in a portion or all of the compound and/or reactants being combined together. The intermixing can be accomplished using a variety of methods known to those skilled in the art, such as conventional mixing, blending, suspending one compound into another, dissolving one compound into another, and the like, or any combination thereof.

It is understood that, in any compound described herein having one or more chiral centers, if an absolute stereochemistry is not expressly indicated, then each center may independently be of R-configuration or S-configuration or a mixture thereof. Thus, the compounds provided herein may be enatiomerically pure or be stereoisomeric mixtures. In addition it is understood that, in any compound described herein having one or more double bond(s) generating geometrical isomers that can be defined as E or Z each double bond may independently be E or Z a mixture thereof. Likewise, all tautomeric forms are also intended to be included.

An embodiment described herein relates to a method of preparing a polymer conjugate that can include: reacting a first reactant and a second reactant in the presence of a water-soluble coupling agent to yield a reaction mixture; wherein the first reactant can be a polymer that includes a recurring unit of Formula (I):

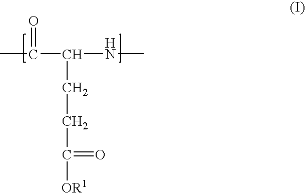

wherein R¹ can be selected from hydrogen, an alkali metal and ammonium; wherein the second reactant can include a compound that includes a first anti-cancer drug; wherein the reaction mixture can include a polymer conjugate that includes a recurring unit of Formula (I) and a recurring unit of Formula (Ia):

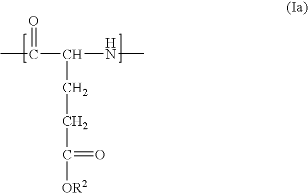

wherein R² can include the first anti-cancer drug; with the proviso that the method does not include reacting a third reactant with the first reactant, wherein the third reactant includes an agent selected from a second anti-cancer drug, a targeting agent, an optical imaging agent, a magnetic resonance imaging agent (for example a paramagnetic metal chelate), and a stabilizing agent; and wherein the polymer conjugate includes amounts of the recurring units of the Formula (I) and amounts of the recurring units of the Formula (Ia), and wherein the sum of the amounts of the recurring units of the Formula (I) and amounts of the recurring units of the Formula (Ia) is greater than about 50 mole % of the total moles of recurring units in the polymer conjugate. Examples of alkali metal include lithium (Li), sodium (Na), potassium (K), rubidium (Rb), and cesium (Cs). In an embodiment, the alkali metal can be sodium.

Various anti-cancer drugs can be used in the methods described herein. In some embodiments, the first anti-cancer drug can be a taxane, a camptotheca, an anthracycline, etoposide, teniposide and epothilone. In an embodiment, the anti-cancer drug can be a taxane, such as paclitaxel or docetaxel. In some embodiments, the anti-cancer drug can be a camptotheca, for example, camptothecin. In an embodiment, the anti-cancer drug can be an anthracycline such as doxorubicin.

Likewise, various water soluble coupling agents can be used in the methods described herein. In an embodiment, the water-soluble coupling agent can be 1-ethyl-3-(3-dimethylaminopropyl)-carbodiimide (EDC). In some embodiments, the method for making the polymer conjugate cannot include using dicyclohexylcarbodiimide (DCC).

If desired, the first and second reactants can be intermixed in a solvent. A variety of solvents known to those skilled in the art can be used. In some embodiments, a portion of the first reactant and/or the second reactant can be dissolved in a solvent before being intermixed. In other embodiments, the first reactant and/or the second reactant can be completely dissolved in a solvent before being intermixed. In desired and/or needed, an additional amount of solvent can be added to the reaction after at least a portion of the first and a portion of the second reactant have been intermixed together. Likewise, the water-soluble coupling agent can also be partially or completely dissolved in a solvent. In an embodiment, the solvent can be dimethylformamide (DMF).

In some embodiments, the methods described herein can further include using a catalyst. In an embodiment, the reaction of the first reactant and the second reactant can be in the presence of a catalyst. Suitable catalysts are known to those skilled in the art. One example of a suitable catalyst is 4-dimethylaminopyridine (DMAP). In some embodiments, the catalyst can be partially or completely dissolved in a solvent, for example, DMF.

The polymer that includes a recurring unit of Formula (I) can be a copolymer or a homopolymer. In an embodiment, the polymer that includes a recurring unit of Formula (I) can be polyglutamate or polyglutamic acid. If the polymer that includes a recurring-unit of Formula (I) is a copolymer, various additional units can be included in the polymer.

The percentage of recurring units of Formula (I) and Formula (Ia) in the polymer conjugate can vary over a wide range. In an embodiment, the sum of the amounts of the recurring units of the Formula (I) and amounts of the recurring units of the Formula (Ia) is greater than 50 mole % of the recurring unit of Formula (I) and the recurring unit Formula (Ia), based on the total moles of recurring units in the polymer conjugate. In another embodiment, the sum of the amounts of the recurring units of the Formula (I) and amounts of the recurring units of the Formula (Ia) is greater than 60 mole % of the recurring unit of Formula (I) and the recurring unit Formula (Ia) (same basis). In still another embodiment, the sum of the amounts of the recurring units of the Formula (I) and amounts of the recurring units of the Formula (Ia) is greater than 70 mole % of the recurring unit of Formula (I) and the recurring unit Formula (Ia) (same basis). In yet still another embodiment, the sum of the amounts of the recurring units of the Formula (I) and amounts of the recurring units of the Formula (Ia) is greater than 80 mole % of the recurring unit of Formula (I) and the recurring unit Formula (Ia) (same basis). In an embodiment, the sum of the amounts of the recurring units of the Formula (I) and amounts of the recurring units of the Formula (Ia) is greater than 90 mole % of the recurring unit of Formula (I) and the recurring unit Formula (Ia) (same basis). In another embodiment, the sum of the amounts of the recurring units of the Formula (I) and amounts of the recurring units of the Formula (Ia) is greater than 95 mole % of the recurring unit of Formula (I) and the recurring unit Formula (Ia) (same basis). In still another embodiment, the sum of the amounts of the recurring units of the Formula (I) and amounts of the recurring units of the Formula (Ia) is greater than 99 mole % of the recurring unit of Formula (I) and the recurring unit Formula (Ia) (same basis).

In one embodiment, the polymer conjugate comprises less than about 50 mole %, based on the total moles of recurring units in the polymer conjugate, of a recurring unit selected from the group consisting of a recurring unit of Formula (II) and a recurring unit of Formula (III):

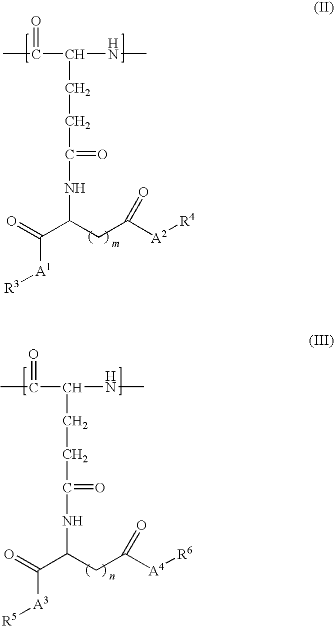

wherein: n and m can be independently 1 or 2; A¹ and A² can be oxygen or NR⁷; A³ and A⁴ can be oxygen; R³, R⁴, R⁵ and R⁶ can be each independently selected from optionally substituted C₁₋₁₀ alkyl, optionally substituted C₆₋₂₀ aryl, ammonium, alkali metal, a polydentate ligand, a polydentate ligand precursor with protected oxygen atoms, and a compound that comprises an agent, wherein the agent is selected from a targeting agent, an optical imaging agent, a magnetic resonance imaging agent, and a stabilizing agent; and R⁷ can be hydrogen or C₁₋₄ alkyl.

In some embodiments the polymer conjugate includes less than about 40 mole % of the recurring unit selected from the recurring unit of Formula (II) and the recurring unit of Formula (III), based on total moles of recurring units in the polymer conjugate. In other embodiments, the polymer conjugate includes less than about 30 mole % of the recurring unit selected from the recurring unit of Formula (II) and the recurring unit of Formula (III) (same basis). In another embodiment, the polymer conjugate includes less than about 20 mole % of the recurring unit selected from the recurring unit of Formula (II) and the recurring unit of Formula (III) (same basis). In another embodiment, the polymer conjugate includes less than about 10 mole % of the recurring unit selected from the recurring unit of Formula (II) and Formula the recurring unit of (III) (same basis). In another embodiment, the polymer conjugate includes less than about 5 mole % of the recurring unit selected from the recurring unit of Formula (II) and the recurring unit of Formula (III) (same basis). In another embodiment, the polymer conjugate includes less than about 1 mole % of the recurring unit selected from the recurring unit of Formula (II) and the recurring unit of Formula (III) (same basis).

Another embodiment described herein relates to a method of isolating a polymer conjugate from the reaction mixture described herein by intermixing an acidic aqueous solution with the reaction mixture and collecting the polymer conjugate. In an embodiment, the intermixing of the acidic aqueous solution with the reaction mixture can induce precipitation of the polymer conjugate.

Various methods known to those skilled in the art can be used to collect the polymer conjugate. For example, the polymer conjugate may be collected by filtration and/or centrifugation.

If desired, the polymer conjugate can be further purified using techniques known to those skilled in the art. These techniques may be used alone, or in combination with other purification techniques. For example, the polymer conjugate may be dialyzed in water.

Suitable acids can be used to create the acidic aqueous solution. In some embodiments, the acid can be a mineral acid. Example of suitable mineral acids include, but are not limited to, hydrochloric acid, hydrobromic acid, sulfuric acid, nitric acid, phosphoric acid, chromic acid or any combination thereof. In an embodiment, the acidic aqueous solution can be a hydrochloric acid aqueous solution.

Similarly, the concentration of the acidic aqueous solution can vary. In an embodiment, the acidic aqueous solution can have a molarity of at least 0.5 M. In another embodiment, the acidic aqueous solution can have a molarity of at least 0.1 M. In still another embodiment, the acidic aqueous solution can have a molarity of at least 0.4 M. In yet still another, the acidic aqueous solution can have a molarity of at least 0.3 M. In an embodiment, the acidic aqueous solution can have a molarity of at least 0.2 M. In another embodiment, the acidic aqueous solution can have a molarity of at least 0.05 M. In still another embodiment, the acidic aqueous solution can have a molarity of at least 0.01 M.

The pH of the acidic acid solution has a pH that is less than 7. In some embodiments, the acidic aqueous solution can have a pH that is less than about 6. In other embodiments, the acidic aqueous solution can have a pH that is less than about 5. In still other embodiments, the acidic aqueous solution can have a pH that is less than about 4. In yet still embodiments, the acidic aqueous solution can have a pH that is less than about 3.

When isolating the polymer conjugate, the intermixing of the acidic aqueous solution with the reaction mixture does not include intermixing an additional amount of organic solvent, wherein the additional amount of organic solvent is greater than about 5% by volume relative to the total volume of the acidic aqueous solution. In an embodiment, the method can utilize less than 5% of an organic solvent by volume relative to the total volume of the acidic aqueous solution. In another embodiment, the intermixing of the acidic aqueous solution with the reaction mixture does not include intermixing an additional amount of organic solvent, wherein the additional amount of organic solvent is greater than about 1% by volume relative to the total volume of the acidic aqueous solution. In still another embodiment, the intermixing of the acidic aqueous solution with the reaction mixture does not include intermixing an additional amount of organic solvent, wherein the additional amount of organic solvent is greater than about 0.5% by volume relative to the total volume of the acidic aqueous solution. In yet still another embodiment, the intermixing of the acidic aqueous solution with the reaction mixture does not include intermixing an additional amount of organic solvent, wherein the additional amount of organic solvent is greater than about 0.1% by volume relative to the total volume of the acidic aqueous solution. In an embodiment, the intermixing of the acidic aqueous solution with the reaction mixture does not include intermixing an additional substantial amount of organic solvent.

In an embodiment, the organic solvent is a chlorinated solvent. Examples of chlorinated solvents include, but are not limited to, chloroform and dichloromethane.

### Examples

The following examples are provided for the purposes of further describing the embodiments described herein, and do not limit the scope of the claims.

### Example 1

### Synthesis of Poly Glutamic Acid—Paclitaxel Conjugate in Sodium Form

Polyglutamic acid (0.63 g) was added to 50 mL of anhydrous dimethylformamide (DMF) and was stirred for 30 min. 1-ethyl-3-(3-dimethylaminopropyl)-carbodiimide (EDC) (193 mg) was added and the reaction mixture was stirred for another 25 min. Afterwards, paclitaxel (0.37 g) and 30 mg of 4-dimethylaminopyridine (DMAP) was added, and the reaction mixture was stirred for 18 h at room temperature. Additional EDC (70 mg) was then added and the reaction mixture was stirred for an additional 6 hours. The reaction went to completion based on the absence of free paclitaxel as determined by thin layer chromatography (TLC) (100% ethyl acetate as gradient).

A diluted HCl solution (170 mL, 0.2 M) was added to induce precipitation. The precipitate was collected by centrifugation. The sodium salt of the polymer conjugate was obtained by dissolving the precipitate with a 0.5 M NaHCO₃ solution. The solution was dialyzed for 24 hours in water (4L×4 times) using cellulose semi-membrane (MW cut off 10,000) for 24 h. The resulting clear colorless solution was filtered through a 0.45 μm filter and lyophilized. 780 mg of the polyglutamic acid-paclitaxel conjugate (PGA-PTX) was obtained. The polyglutamic acid-paclitaxel conjugate (PGA-PTX) was confirmed by ¹H NMR. The PGA-PTX conjugate was also confirmed by gel permeation chromatography (GPC) with multi-angle light scattering detectors. Additionally, the paclitaxel content was determined by UV-Vis spectroscopy.

### Example 2

### Synthesis of Poly Glutamic Acid—Paclitaxel Conjugate in Acidic Form

Polyglutamic acid (0.63 g) was added to 50 mL of anhydrous dimethylformamide (DMF) and was stirred for 30 min. 1-ethyl-3-(3-dimethylaminopropyl)-carbodiimide (EDC) (193 mg) was added and the reaction mixture was stirred for another 25 min. Afterwards, paclitaxel (0.37 g) and 30 mg of 4-dimethylaminopyridine (DMAP) was added, and the reaction mixture was stirred for 18 h at room temperature. Additional EDC (70 mg) was then added and the reaction mixture was stirred for an additional 6 hours. The reaction went to completion based on the absence of free paclitaxel as determined by thin layer chromatography (TLC) (100% ethyl acetate as gradient).

A diluted HCl solution (170 mL, 0.2 M) was added to induce precipitation. The precipitate was collected by centrifugation. The sodium salt of the polymer conjugate was obtained by dissolving the precipitate with a 0.5 M NaHCO₃ solution. The solution was dialyzed for 24 hours in water (4L×4 times) using cellulose semi-membrane (MW cut off 10,000) for 24 h. The resulting clear colorless solution was filtered through a 0.45 μm filter and lyophilized.

The solution was then treated with a 0.5 M HCl solution. The solid precipitate that was formed was isolated by centrifugation. The resulting power was then washed twice with water and lyophilized. 800 mg of the polyglutamic acid-paclitaxel conjugate (PGA-PTX) was obtained. The paclitaxel content was determined by UV-Vis spectroscopy.

It will be understood by those of skill in the art that numerous and various modifications can be made without departing from the spirit of the present invention. Therefore, it should be clearly understood that the forms of the present invention are illustrative only and not intended to limit the scope of the present invention.

What is claimed is:

1. A method of preparing a polymer conjugate, comprising:
reacting a first reactant and a second reactant in the presence of a water-soluble coupling agent to yield a reaction mixture;
wherein the first reactant is a polymer comprising a recurring unit of Formula (I): 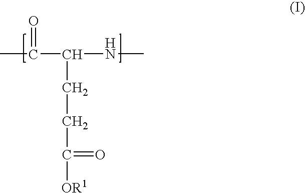
wherein R¹ is selected from the group consisting of hydrogen, an alkali metal and ammonium;
wherein the second reactant comprises a compound that comprises a first anti-cancer drug;
wherein the reaction mixture comprises a polymer conjugate comprising a recurring unit of Formula (I) and a recurring unit of Formula (Ia): 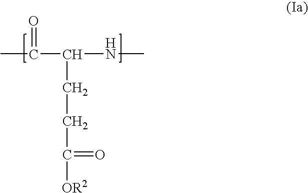
wherein R² comprises the first anti-cancer drug;
with the proviso that the method does not include reacting a third reactant with the first reactant, wherein the third reactant comprises an agent selected from the group consisting of a second anti-cancer drug, a targeting agent, an optical imaging agent, a magnetic resonance imaging agent, and a stabilizing agent; and
wherein the polymer conjugate includes amounts of the recurring units of the Formula (I) and amounts of the recurring units of the Formula (Ia), and wherein the sum of the amounts of the recurring units of the Formula (I) and amounts of the recurring units of the Formula (Ia) is greater than about 50 mole % of the total moles of recurring units in the polymer conjugate.

2. The method of claim 1, comprising reacting the first reactant and the second reactant in the presence of a catalyst.

3. The method of claim 1, wherein the first anti-cancer drug is selected from the group consisting of a taxane, a camptotheca, an anthracycline, etoposide, teniposide and epothilone.

4. The method of claim 3, where the taxane is paclitaxel or docetaxel.

5. The method of claim 3, where the camptotheca is camptothecin

6. The method of claim 3, wherein the antracycline is doxorubicin.

7. The method of claim 1, further comprising intermixing the first reactant and the second reactant in a solvent.

8. The method of claim 7, wherein the solvent is dimethylformamide.

9. The method of claim 1, wherein the sum of the amounts of the recurring units of the Formula (I) and amounts of the recurring units of the Formula (Ia) is greater than about 60 mole %.

10. The method of claim 1, wherein the polymer conjugate comprises less than about 50 mole %, based on the total moles of recurring units in the polymer conjugate, of a recurring unit selected from the group consisting of a recurring unit of Formula (II) and a recurring unit of Formula (III): 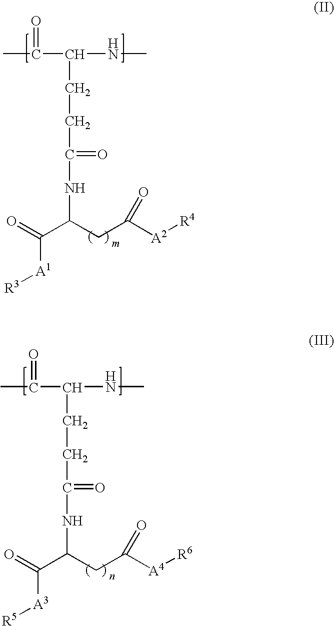
wherein:
n and m is independently 1 or 2;
A¹ and A² are oxygen or NR⁷;
A³ and A⁴ are oxygen;
R³, R⁴, R⁵ and R⁶ are each independently selected from the group consisting of optionally substituted C₁₋₁₀ alkyl, optionally substituted C₆₋₂₀ aryl, ammonium, alkali metal, a polydentate ligand, a polydentate ligand precursor with protected oxygen atoms, and a compound that comprises an agent, wherein the agent is selected from the group consisting of a targeting agent, an optical imaging agent, a magnetic resonance imaging agent, and a stabilizing agent; and
R⁷ is hydrogen or C₁₋₄ alkyl.

11. The method of claim 10, wherein the polymer conjugate comprises less than about 40 mole % of the recurring unit selected from the group consisting of the recurring unit of Formula (II) and the recurring unit of Formula (III) based on the total moles of recurring units in the polymer conjugate.

12. The method of claim 1, wherein the polymer is polyglutamic acid or polyglutamate.

13. The method of claim 1, wherein the water soluble coupling agent is 1-ethyl-3-(3-dimethylaminopropyl)-carbodiimide (EDC).

14. A method of isolating the polymer conjugate of claim 1 comprising intermixing an acidic aqueous solution with the reaction mixture and collecting the polymer conjugate.

15. The method of claim 14, wherein the acidic aqueous solution has a pH that is less than about 3.

16. The method of claim 14, wherein the acidic aqueous solution is at least about 0.2 M of a mineral acid.

17. The method of claim 16, wherein the mineral acid is hydrochloric acid.

18. The method of claim 14, wherein the intermixing of the acidic aqueous solution with the reaction mixture induces precipitation of the polymer conjugate.

19. The method of claim 14, wherein the intermixing of the acidic aqueous solution with the reaction mixture does not include intermixing an additional amount of organic solvent, wherein the additional amount of organic solvent is greater than about 5% by volume relative to the total volume of the acidic aqueous solution.

20. The method of claim 19, wherein the organic solvent is a chlorinated solvent.
